(19) United States
(12) Patent Application Publication
(10) Pub. No.: US 2022/0285666 A1
(43) Pub. Date: Sep. 8, 2022

(54) POROUS MICROSTRUCTURES FOR ION STORAGE IN HIGH CAPACITY ELECTRODES BASED ON SURFACE SEGREGATION-INDUCED SEPARATION

(71) Applicants: The Trustees of Indiana University, Indianapolis, IN (US); Argonne National Laboratory, Lemont, IL (US)

(72) Inventors: Likun Zhu, Zionsville, IN (US); Shengfeng Yang, Carmel, IN (US); Xinwei Zhou, Zionsville, IN (US); Yuzi Liu, Lemont, IL (US)

(73) Assignee: The Trustees of Indiana University, Indianapolis, IN (US)

(21) Appl. No.: 17/632,490

(22) PCT Filed: Sep. 8, 2020
(86) PCT No.: PCT/US20/49643

§ 371 Date: Feb. 3, 2022

Related U.S. Application Data
(60) Provisional application No. 62/898,893, filed on Sep. 11, 2019.

(51) Int. Cl. H01M 4/13; H01M 10/054; H01M 10/0525

(52) U.S. Cl. CPC H01M 4/13; H01M 10/054; H01M 10/0525; H01M 2004/021

(57) ABSTRACT

A porous microstructure includes: a solid material, wherein the solid material allows conductivity of ions; and a plurality of nanopores defined within the solid material.

### RELATED APPLICATIONS

The present application is based on and claims priority to U.S. Provisional Application Ser. 62/898,893, filed on Sep. 11, 2019, the entire disclosure of which being hereby expressly incorporated herein by reference.

### GOVERNMENT RIGHTS

This invention was made with government support under 1603847 awarded by National Science Foundation. The Government has certain rights in the invention.

### TECHNICAL FIELD

Aspects of this disclosure relate to rechargeable battery technologies. More specifically, embodiments relate to engineered porous microstructures for use in ion battery electrodes.

### BACKGROUND

Advanced lithium ion battery (LIB) technologies have been considered promising in the realization of electric vehicles because they have high energy and power density relative to other cell chemistries. Despite the great progress in research on advanced battery technologies, challenges still exist to increase the energy and power densities, reduce the cost, and improve the safety and life of the batteries for electric vehicles to be cost-competitive with the gasoline-powered automobile. During the last decade, many research efforts have been made to develop new active electrode materials for LIBs. For instance, alloy-type anode materials, such as Si, Ge and Sn, have been widely studied because of their much higher storage capacity compared to graphite (372 mAh/g). One challenge in the development of alloy-type anodes is the high volume change involved in the reaction scheme. Si, Ge and Sn have about a 300% volume change upon charging/discharging, which could result in particle fracture and electrode delamination from the current collector, thereby leading to rapid loss of specific capacity. In addition to alloy-type materials, lithium metal anode has been considered the “Holy Grail” of battery technologies, due to its light weight, lowest anode potential, and high specific capacity (3,860 mAh/g). However, dendrite growth and virtually relative infinite volume change during long-term cycling lead to severe safety hazards and fast capacity fading. The side reaction between liquid electrolyte and lithium metal during cycling is the major reason for lithium dendrite formation and continuous consumption of electrolyte.

One of the strategies being implemented towards the utilization of lithium metal electrodes includes developing solid state batteries by replacing LIB's liquid electrolyte with ion-conducting solid electrolytes (SEs). However, even with highly ion-conductive SEs, obstacles still lie in obtaining good SE battery performance comparable to that of LIB using the liquid electrolyte. According to the model of Monroe and Newman, an SE with a shear modulus two times higher than that of metallic Li should suppress Li dendrite penetration into the SE. With this advantage, Li metal anode could be used in all-solid LIBs to increase the energy density significantly. However, recent studies show that Li dendrites still penetrates into SEs through grain boundaries or pores. Furthermore, it has been shown that many SEs have irreversible reactions at electrode/SE interface, forming undesirable solid electrolyte interface (SEI) layer.

To implement lithium metal anode in high energy density battery systems, two issues need to be addressed. The first one is to prevent lithium metal from contacting liquid electrolyte. The second one is to provide voids for the volume change of lithium metal during cycling.

### SUMMARY

In one embodiment, the present disclosure provides a porous microstructure, comprising: a solid material, wherein the solid material allows conductivity of ions; and a plurality of nanopores defined within the solid material. In one aspect of this embodiment, the ions are lithium ions. In a variant of this aspect, the microstructure is configured to be used as an electrode in a lithium-ion battery. In another aspect, the ions are sodium ions. In a variant of this aspect, the microstructure is configured to be used as an electrode in a sodium-ion battery. Yet another aspect of this embodiment further comprises a surface configured to facilitate ion segregation. In a variant of this aspect, the surface is one of a grain boundary, a surface between two solid materials or a free surface. In still another aspect, each of the plurality of nanopores has a diameter of less than ten nanometers. In another aspect, each of the plurality of nanopores has a diameter of less than five nanometers.

In another embodiment of the present disclosure a rechargeable battery is provided, comprising: a porous microstructure configured to facilitate surface ion storage thereon, the porous microstructure comprising: a solid material, wherein the solid material allows conductivity of ions; and a plurality of nanopores defined within the solid material; and a substance comprising a plurality of ions, wherein the microstructure is configured to facilitate segregation of the plurality of ions on a surface of the microstructure. In one aspect of this embodiment, each nanopore has a diameter of less than ten nanometers. In another aspect, each nanopore has a diameter of less than five nanometers. In still another aspect, the ions are lithium ions. In a variant of this aspect, the microstructure is configured to be used as an electrode in a lithium-ion battery. In another aspect, the ions are sodium ions. In a variant of this aspect, the microstructure is configured to be used as an electrode in a sodium-ion battery. In yet another aspect of this embodiment, the surface is one of a grain boundary, a surface between two solid materials or a free surface.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a perspective view of a portion of a porous microstructure, in accordance with embodiments of the disclosure.

FIG. 2A is a transmission electron microscopy (TEM) image of a sample microstructure, in accordance with embodiments of the disclosure.

FIG. 2B is a high resolution TEM (NREM) image of nanopores of the sample microstructure depicted in FIG. 2A, in accordance with embodiments of the disclosure.

FIG. 2C is the electron diffraction pattern of Ge, in accordance with embodiments of the disclosure.

FIG. 2D is a TEM image of the sample microstructure depicted in FIGS. 2A and 2B after delithiation, in accordance with embodiments of the disclosure.

FIG. 2E is an EFTEM mapping of Ge in the sample microstructure depicted in FIGS. 2A, 2B, and 2D after delithiation, in accordance with embodiments of the disclosure.

FIG. 2F is an EFTEM mapping of Li in the sample microstructure depicted in FIGS. 2A, 2B, 2D, and 2E after delithiation, in accordance with embodiments of the disclosure.

FIG. 3A is a cryo TEM image of a GE sample after delithiation, in accordance with embodiments of the disclosure.

FIG. 3B is a cryo EFTEM mapping of Li after delithiation, in accordance with embodiments of the disclosure.

FIG. 3C is a cryo TEM image of nanopores, in accordance with embodiments of the disclosure.

FIGS. 4A-4F are aspects of a computational model of segregation of Li at the pore surface in Si, in accordance with embodiments of the disclosure.

### DETAILED DESCRIPTION

While the disclosed subject matter is amenable to various modifications and alternative forms, specific embodiments have been shown by way of example in the drawings and are described in detail below. The intention, however, is not to limit the subject matter disclosed herein to the particular embodiments described. On the contrary, the disclosure is intended to cover all modifications, equivalents, and alternatives falling within the scope of the subject matter disclosed herein, and as defined by the appended claims.

As used herein in association with values (e.g., terms of magnitude, measurement, and/or other degrees of qualitative and/or quantitative observations that are used herein with respect to characteristics (e.g., dimensions, measurements, attributes, components, etc.) and/or ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a value, configuration, orientation, and/or other characteristic that is equal to (or the same as) the stated value, configuration, orientation, and/or other characteristic or equal to (or the same as) a value, configuration, orientation, and/or other characteristic that is reasonably close to the stated value, configuration, orientation, and/or other characteristic, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

Embodiments include a porous engineered microstructure for use as a battery electrode. For example, the porous engineered structure may be used as a lithium metal electrode in a lithium-ion battery. In other examples, the porous engineered structure may be used as an electrode in a sodium-ion battery. The material of the microstructure may be configured to have good ion conductivity (e.g., lithium ion conductivity, sodium ion conductivity, etc.). The size of each pore of the porous microstructure may be configured to be in the several nanometer range. Accordingly, in embodiments, the pores of the microstructure may be referred to, interchangeably, as nanopores. In embodiments, the porous structure may be configured to provide a large surface area storage medium for ions that are segregated on the surface. Based on the segregation mechanism, for example, lithium metal can be plated and striped in the nanopores. According to embodiments, the porous engineered microstructure can be used, thereby providing voids for storage of the lithium while preventing contact between liquid electrolyte and lithium metal.

In embodiments, the porous microstructure may provide a free surface, a surface on a grain boundary, a surface between two solid materials, and/or the like. The surface may be configured to facilitate ion segregation (e.g., lithium segregation) on the surface, which enables the microstructure to be used for ion storage. In this manner, embodiments of the microstructure may be used for high capacity battery systems, to develop rechargeable batteries with high energy density, long cycle life, and low cost. Embodiments of batteries implementing microstructures such as those described herein may include batteries used in portable electronics, hybrid vehicles, electric vehicles, grid-scale energy storage systems, and/or the like.

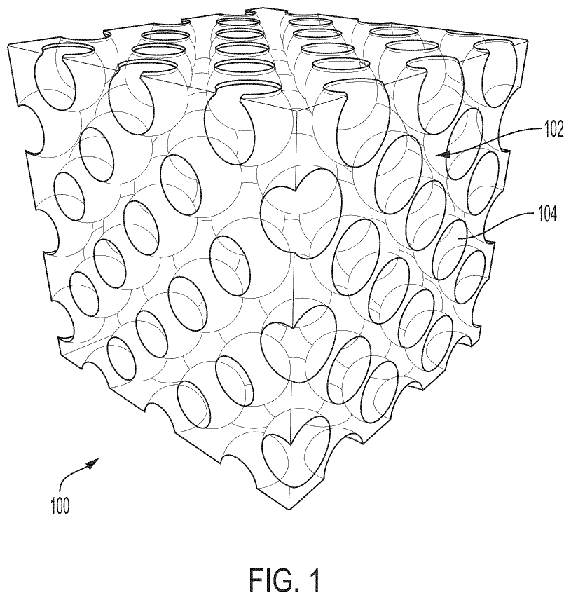

FIG. 1 shows a portion of an illustrative porous engineered microstructure 100, in accordance with embodiments of the disclosure. The microstructure 100 includes a solid material 102 having a number of nanpores 104 defined therein. According to embodiments, the microstructure 100 may be configured to have any number of different shapes so as to be implemented as an electrode in an ion battery such as, for example, a lithium-ion battery, a sodium-ion battery, and/or the like. The microstructure 100 may be made using any number of construction methods and may be made from any number of different types of material selected to facilitate conductivity of the associated ions (e.g., lithium ions, sodium ions, etc.). Such materials may include, for example, LiB electrode materials (e.g., Si, Ge, Sn, C Li2TiO3, LiCoO2, LiFePO4, NMC, etc.), solid electrolyte materials (e.g., LLZO, LGPS, lithium sulfide, etc.), and/or the like.

The size of each pore 104 of the porous microstructure 100 may be configured to be in the several nanometer range. For example, each nanopore 104 may include a diameter of less than five nanometers, less than ten nanometers, and/or the like. In embodiments, the nanopores 104 may be configured to have a size that maximizes the surface area, while maintaining integrity—that is, the nanopores 104 may be as large as possible without making the surrounding material 102 so thin that it cannot maintain its shape.

The illustrative microstructure 100 shown in FIG. 1 is not intended to suggest any limitation as to the scope of use or functionality of embodiments of the present disclosure. The illustrative microstructure 100 also should not be interpreted as having any dependency or requirement related to any single component or combination of components illustrated therein. Additionally, various components depicted in FIG. 1 may be, in embodiments, integrated with various ones of the other components depicted therein (and/or components not illustrated), all of which are considered to be within the ambit of the present disclosure.

### Experimental Results

In the illustrated study, an in situ focused-ion beam-scanning electron microscope (FIB-SEM) method was used to study the lithium segregation in the nanopores formed during the delithiation process of Ge particles. The experiment was performed on a Zeiss Nvision 40 FIB-SEM at the Center for Nanoscale Materials, Argonne National Laboratory. The ionic liquid electrolyte was made by dissolving the Li salt, lithium bis (trifluoromethylsulfonyl) imide (LiTFSI) (Sigma-Aldrich), in a solvent of 1-butyl-1-methylpyrrolidinium bis (trifluoromethylsulfonyl) imide (P14TFSI) (Sigma-Aldrich). A Keithley 6430 sub-femtoamp remote sourcemeter was used to control the current. During cycling, the Ge particle was immersed in electrolyte. The galvanostatic mode was used in all cycling with a voltage window between 0.01 and 1.5 V. To investigate the distribution of nanopores, a Ge particle cycle at 1 nA for 1 cycle was transferred to a TEM grid and a FIB-SEM tomography was conducted. A JEOL JEM2100F TEM was employed for the microstructure analysis.

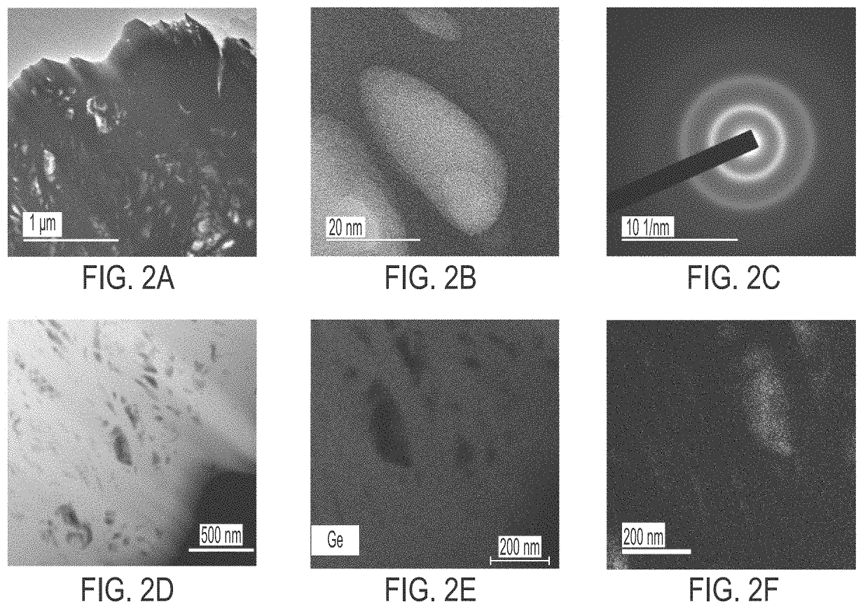

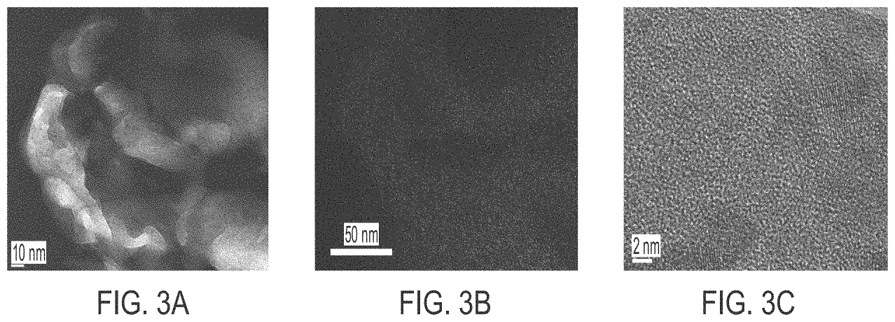

FIG. 2A is a low magnification micrograph of the sample. FIG. 2B is a high resolution TEM (NREM) image of nanopores. FIG. 2C is the electron diffraction pattern of Ge which indicates the Ge's crystal structure becomes amorphous after the delithiation process. FIGS. 2E and 2F show that lithium remains in the nanopores after delithiation. In order to confirm the existence of lithium in the nanopores, a cryo TEM was conducted to detect the crystalline structure of lithium in the nanopores. As shown in FIGS. 3A-3C, crystalline structures appear in the nanopores. These results indicate that it is possible that lithium metal can be segregated and separated in the nano-pores in Ge.

Computational Results

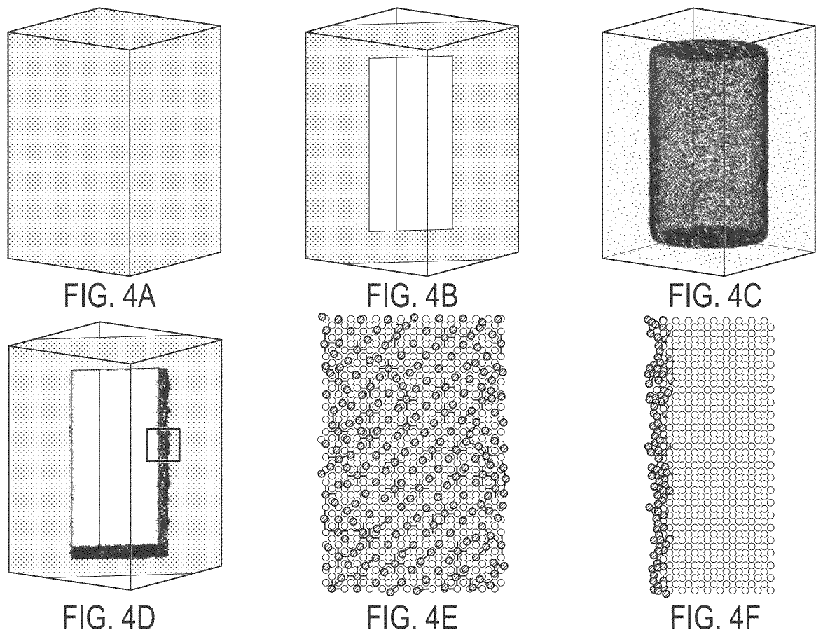

In order to explain the TEM results shown in FIGS. 2A-2F and 3A-3C, a computational simulation was conducted. As shown in FIG. 4A, a rectangular atomistic model of pure Si is built with the dimension of 20 nm*20 nm*30 nm (˜37a*37a*56a), where a is the lattice constant of Si. To mimic the experimental results, a cylindrical pore is created inside with the diameter of 15 nm. The length of this cylindrical pore is 25 nm and it is located in the middle of the rectangular model (shown in FIG. 4B). The pore surface area is 1,531.52 nm2 and the surface area to volume ratio is about 0.2 nm-1. The total number of atoms in the model is 392,098. To approximate a large system by using a small computational model and avoid the surface effect of the model, periodic boundary conditions are used for all the directions of the model. A second nearest-neighbor embedded atom method interatomic potential is used to describe the interatomic interaction for Li—Li, Li—Si, and Si—Si in the atomistic simulations.

The model was first relaxed by using molecular dynamic simulations (MD) at the temperature of 300K to reach equilibrium. The external pressure on the model is zero, which means the model can freely expand or shrink during the simulation. In order to simulate the segregation of Li, hybrid Monte Carlo and molecular dynamic (MC/MD) simulations were performed to introduce Li into the pure Si Model at 300K. A chemical potential difference of 3.0 eV between Li and Si was used in MC/MD simulations. The simulation results indicate significant segregation of Li atoms at the surface of the pore, as shown in FIGS. 4C and 4D. The zoom-in images (FIGS. 4E and 4F) shows that a monolayer of Li atoms are formed at the pore surfaces. The results clearly suggest that Li atoms tend to segregate to the surface of the nano-sized pore rather than the Si bulk.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A porous microstructure, comprising:
a solid material, wherein the solid material allows conductivity of ions; and
a plurality of nanopores defined within the solid material.

2. The microstructure of claim 1, wherein the ions are lithium ions.

3. The microstructure of claim 2, wherein the microstructure is configured to be used as an electrode in a lithium-ion battery.

4. The microstructure of claim 1, wherein the ions are sodium ions.

5. The microstructure of claim 4, wherein the microstructure is configured to be used as an electrode in a sodium-ion battery.

6. The microstructure of claim 1, further comprising a surface configured to facilitate ion segregation.

7. The microstructure of claim 6, wherein the surface is one of a grain boundary, a surface between two solid materials or a free surface.

8. The microstructure of claim 1, wherein each of the plurality of nanopores has a diameter of less than ten nanometers.

9. The micro structure of claim 1, wherein each of the plurality of nanopores has a diameter of less than five nanometers.

10. A rechargeable battery, comprising:
a porous microstructure configured to facilitate surface ion storage thereon, the porous microstructure comprising:
a solid material, wherein the solid material allows conductivity of ions; and
a plurality of nanopores defined within the solid material; and
a substance comprising a plurality of ions, wherein the microstructure is configured to facilitate segregation of the plurality of ions on a surface of the microstructure.

11. The battery of claim 10, wherein each nanopore has a diameter of less than ten nanometers.

12. The battery of claim 10, wherein each nanopore has a diameter of less than five nanometers.

13. The battery of claim 10, wherein the ions are lithium ions.

14. The battery of claim 13, wherein the microstructure is configured to be used as an electrode in a lithium-ion battery.

15. The battery of claim 10, wherein the ions are sodium ions.

16. The battery of claim 15, wherein the microstructure is configured to be used as an electrode in a sodium-ion battery.

17. The microstructure of claim 10, wherein the surface is one of a grain boundary, a surface between two solid materials or a free surface.
